(19) United States
(12) Patent Application Publication
(10) Pub. No.: US 2009/0184752 A1
(43) Pub. Date: Jul. 23, 2009

(54) BIAS CIRCUIT

(75) Inventor: Masahiro KUDO, Kawasaki (JP)

Correspondence Address: ARENT FOX LLP, 1050 CONNECTICUT AVENUE, N.W., SUITE 400, WASHINGTON, DC, 20036, US

(73) Assignee: FUJITSU LIMITED, Kawasaki (JP)

(21) Appl. No.: 12/411,104

(22) Filed: Mar. 25, 2009

Related U.S. Application Data
(63) Continuation of application No. PCT/JP2006/319570, filed on Sep. 29, 2006.

(51) Int. Cl. G05F 1/10

(52) U.S. Cl. 327/535

(57) ABSTRACT

A bias circuit includes a first and a second transistors to which a common gate voltage is supplied, a load circuit coupled to drains of the first and the second transistors, a control circuit generating a control signal based on a signal from the load circuit, a current source controlled based on the control signal and coupled to the first and the second transistors, and a first impedance circuit coupled between the second transistor and the current source.

### FIELD

The present embodiments relate to a bias circuit.

### BACKGROUND

FIG. 3 in the Translated National Publication of Patent Application No. 2004-523830 discusses a bias circuit used to bias an operational amplifier. The bias circuit includes a pair of n-channel MOS field-effect transistors coupled to a ground terminal. A pair of p-channel MOS field-effect transistors is coupled between the pair of n-channel MOS field-effect transistors and a positive voltage source. A gm setting resistance is coupled between one of the pair of the n-channel MOS field-effect transistors and the ground terminal. The gm setting resistance is generally placed separated from a chip so as to set a resistance value thereof after the chip is made. The p-channel MOS field-effect transistor pair operates as a current mirror, and the n-channel MOS field-effect transistor pair and the gm setting resistance operate as a current source to input/control current in order that the bias circuit generates a bias current that sets gm of the n-channel MOS field-effect transistor in the operational amplifier to be an amount inversely proportional to the resistance value of the gm setting resistance.

However, in the case when the field-effect transistor has a short channel length, or in the case when the field-effect transistor has a low threshold voltage, accuracy of an analog circuit is deteriorated, and it is impossible to bias an MOS device operating at a high-speed appropriately.

### SUMMARY

According to an aspect of the embodiments, a bias circuit includes a first and a second transistors to which a common gate voltage is supplied, a load circuit coupled to drains of the first and the second transistors, a control circuit generating a control signal based on a signal from the load circuit, a current source controlled based on the control signal and coupled to the first and the second transistors, and a first impedance circuit coupled between the second transistor and the current source.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a circuit diagram depicting a configuration example of a bias circuit according to a first embodiment;

FIG. 2 is a circuit diagram in which a portion of the bias circuit in FIG. 1 is extracted;

FIG. 3 is a graph depicting a relation between a current and a voltage;

FIG. 4 is a circuit diagram depicting a configuration example of a bias circuit and a differential amplifier according to a second embodiment;

FIG. 5 is a circuit diagram depicting a configuration example of a bias circuit according to a third embodiment;

FIG. 6 is a circuit diagram depicting a configuration example of a bias circuit according to a fourth embodiment;

FIG. 7 is a circuit diagram depicting a configuration example of a bias circuit according to a fifth embodiment;

FIG. 8 is a circuit diagram depicting a configuration example of a bias circuit according to a sixth embodiment;

FIG. 9 is a circuit diagram depicting a configuration example of a bias circuit according to a seventh embodiment;

FIG. 10 is a circuit diagram depicting a configuration example of a bias circuit according to an eighth embodiment;

FIG. 11 is a circuit diagram depicting a configuration example of a bias circuit according to a ninth embodiment;

FIG. 12 is a circuit diagram depicting a configuration example of a bias circuit according to a tenth embodiment;

FIG. 13 is a circuit diagram depicting a configuration example of a bias circuit according to an eleventh embodiment;

FIG. 14 is a circuit diagram depicting a configuration example of a bias circuit according to a twelfth embodiment;

FIG. 15 is a circuit diagram depicting a configuration example of a bias circuit according to a thirteenth embodiment;

FIG. 16 is a circuit diagram depicting a configuration example of a bias circuit according to a fourteenth embodiment; and

FIG. 17 is a circuit diagram depicting a configuration example of a bias circuit.

### DESCRIPTION OF EMBODIMENTS

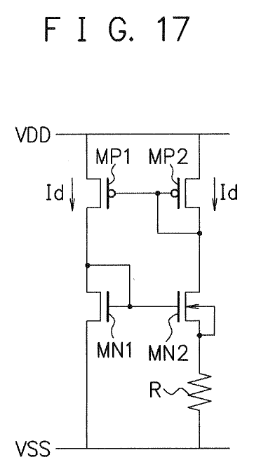

FIG. 17 is a circuit diagram depicting a configuration example of a bias circuit. The bias circuit has a pair of p-channel MOS field-effect transistors MP1 and MP2, a pair of n-channel MOS field-effect transistors MN1 and MN2, and a resistance R. Hereinafter, the MOS field-effect transistor is simply called as a transistor. The p-channel transistors MP1 and MP2 have gates thereof coupled each other, and constitute a current mirror, and a same current flows therethrough. The n-channel transistors MN1 and MN2 also have gates thereof coupled each other, and constitute a current mirror.

The p-channel transistor MP1 has a source thereof coupled to a terminal of a power supply voltage VDD, and a drain thereof coupled to a drain of the n-channel transistor MN1. The p-channel transistor MP2 has a source thereof coupled to the terminal of the power supply voltage VDD, and a drain thereof coupled to a drain of the n-channel transistor MN2. An intercoupling point between the gates of the p-channel transistors MP1 and MP2 is coupled to the drain of the p-channel transistor MP2.

A source of the n-channel transistor MN1 is coupled to a terminal of a reference potential VSS. A source of the n-channel transistor MN2 is coupled to the terminal of the reference potential VSS via the resistance R. An intercoupling point between the gates of the n-channel transistors MN1 and MN2 is coupled to the drain of the n-channel transistor MN1. The n-channel transistor MN2 has a substrate terminal thereof coupled to a source terminal thereof.

This bias circuit generates a bias current to supply to a transistor such as a differential amplifier. In a saturation region of the transistor, a drain current Id and transconductance gm are expressed by expressions (1) and (2). The transconductance gm expresses how the current varies depending on a voltage variation.

Id=(β/2)×Vod² (1)

gm=β×Vod=√(2×β×Id) (2)

Herein, an overdrive voltage Vod is defined by an expression (3) based on a gate-source voltage Vgs and a threshold voltage Vth.

Vod=Vgs−Vth (3)

Further, a coefficient β is expressed by an expression (4).

β=μ×Cox×W/L (4)

Herein, μ indicates mobility of the transistor, Cox indicates gate oxide film capacitance, W indicates a channel width, and L indicates a channel length.

This bias circuit generates a bias current Id to keep the transconductance gm constant even though β and/or Vth of the transistor vary/varies due to variation of a process. In an analog circuit such as an amplifier or a filter, or the like, gm of the transistor becomes an important parameter for a characteristic of the analog circuit, and therefore, receiving a supply of the bias current Id to keep gm constant from the bias circuit makes it possible to realize stabilization of the characteristic and high performance, for example.

Next, the reason why this bias circuit generate the bias current to keep gm constant is explained. For example, a channel width W of the n-channel transistor MN2 is four times as large as a channel width W of the n-channel transistor MN1. And then, according to the expression (4), β of the n-channel transistor MN2 becomes four times as large as β of the n-channel transistor MN1.

With the expression (1), the drain current Id of the n-channel transistor MN1 is expressed by an expression (5), and the drain current Id of the n-channel transistor MN2 is expressed by an expression (6).

Id=(β/2)×Vod² (5)

Id=(4×β/2)×(Vod−Id×R)² (6)

Since the transistors MP1 and MP2 constitute the current mirror, and the same current Id flows therethrough, the same current Id also flows in the transistors MN1 and MN2. Accordingly, the currents Id in the expressions (5) and (6) result in the same value, and an expression (7) is established as follows.

(β/2)×Vod²=(4×β/2)×(Vod−Id×R)²

Vod²=4×(Vod−Id×R)²

Vod=2×(Vod−Id×R) (7)

When substituting the expression (1) for the current Id of the expression (7), an expression (8) is established.

Vod=2×(Vod−(β/2)×Vod²×R) (8)

Next, when substituting the expression (2) for the expression (8), an expression (9) is established.

Vod=2×(Vod−gm×Vod×R/2)

1=2×(1−gm×R/2)

1=2−gm×R

gm=1/R (9)

As indicated in the expression (9), gm is a constant not depending on β or Vth, and therefore, the bias circuit is to be able to generate the bias current Id to keep gin constant. Similarly to in the transistors MN1 and MN2 in which gm is controlled to be constant, polarity and the channel lengths of the transistors MN1 and MN2 are designed to be the same as those of the transistor that functions actually so that gm of the transistor which functions actually by receiving a supply of the bias current is controlled to be constant. Further, the overdrive voltages of the transistors MN1 and MN2 are also designed to operate at a value close to the overdrive voltage of the transistor that functions actually, and for example, the overdrive voltage of the transistor that functions actually is designed to be an intermediate between the overdrive voltage of the transistor MN1 and the overdrive voltage of the transistor MN2.

Generally, the channel length L of the transistor needs to be short in order to make the transistor operate at a high speed. In the case when the channel length L of the transistor that is desired to keep gm constant is made short, the transistor in the bias circuit corresponding thereto as well needs to be designed with the channel L being made short, however, when the channel length L is made short, a drain-source resistance Rds of the transistor becomes small. And then, drain voltage dependence of the drain currents of the transistors MN1 and MN2 becomes large, and an error current occurs due to a drain voltage difference between the transistors MN1 and MN2, which makes it difficult to generate the appropriate bias current Id.

Further, at present, lowering voltage of a power supply advances, and there is a case that a transistor with a low threshold voltage whose threshold voltage Vth is low is used in order to secure a bias voltage and a signal amplitude in an analog circuit. This bias circuit uses the saturation region of the transistor where the large drain-source resistance may be secured, however, when the threshold voltage Vth lowers, as for the diode-coupled transistor MN1, since the drain voltage and the gate voltage are equal, the bias circuit is to use a vicinity of a boundary between the saturation region and a linear region. The drain voltage dependence of the drain current of the transistor MN1 thus becomes large, and the error current occurs due to the drain voltage difference between the transistors MN1 and MN2, which makes it difficult to generate the appropriate bias current Id.

In embodiments hereinafter, there will be explained a bias circuit capable of generating a bias current to keep gm constant even in the case when the channel length L of the transistor is short and/or even in the case when the threshold voltage Vth of the transistor is low.

### First Embodiment

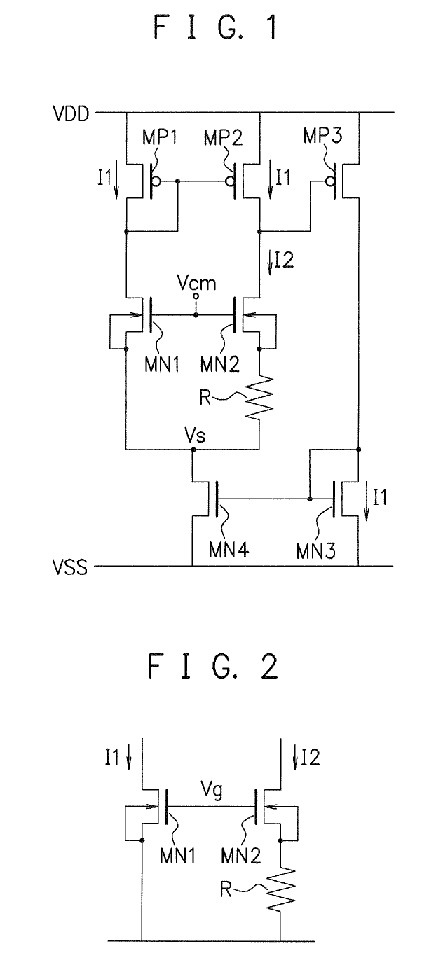

FIG. 1 is a circuit diagram depicting a configuration example of a bias circuit according to a first embodiment, and in FIG. 1, transistors MP3, MN3 and MN4 are added to the circuit in FIG. 17. Here, an intercoupling point between gates of transistors MP1 and MP2 is coupled to a drain of the transistor MP1. The bias circuit in this embodiment may basically generate a bias current I1 to keep gm constant according to the similar principle as that of the bias circuit in FIG. 17.

For example, a channel width W of a transistor MN2 is four times as large as a channel width W of a transistor MN1, and channel widths W of the transistors MP1 to MP3 are all the similar, and a channel width W of the transistor MN4 is twice as large as that of the transistor MN3. Channel lengths L of the transistors MN1 to MN4 and MP1 to MP3 are the similar one another.

In the transistors MN1 and MN2, ratios Id/K of drain currents Id to ratios K=W/L between the channel width W and the channel length L are different from each other. For example, the channel width W of the transistor MN2 is four times as large as the channel width W of the transistor MN1, and the channel lengths L of the transistors MN1 and MN2 are the similar each other. Note that, as will be explained later, a drain current I1 of the transistor MN1 and a drain current I2 of the transistor MN2 are the similar each other. That is, in the transistors MN1 and MN2, the channel lengths L are the similar each other, and the ratios Id/W of the drain currents Id to the channel width W are different from each other. Note that the channel width W of the transistor MN2 is set to be four times as large as the channel width W of the transistor MN1 in this embodiment, however, which is not limited to this scaling factor, and it is possible to configure the bias circuit by using another scaling factor and another current ratio, for example.

The bias circuit has a pair of the p-channel transistors MP1 and MP2 and a pair of the n-channel transistors MN1 and MN2. The p-channel transistors MP1 and MP2 have the gates thereof coupled each other, and constitute a current mirror, and a similar current flows therethrough. The n-channel transistors MN1 and MN2 have gates thereof coupled each other, and a bias voltage Vcm is supplied to the gates.

The p-channel transistor MP1 has a source thereof coupled to a terminal of a power supply voltage VDD, and the drain thereof coupled to a drain of the n-channel transistor MN1. The p-channel transistor MP2 has a source thereof coupled to the terminal of the power supply voltage VDD, and a drain thereof coupled to a drain of the n-channel transistor MN2. The intercoupling point between the gates of the p-channel transistors MP1 and MP2 is coupled to the drain of the p-channel transistor MP1.

A source of the n-channel transistor MN1 is coupled to a drain of the n-channel transistor MN4. A source of the n-channel transistor MN2 is coupled to the drain of the transistor MN4 via a resistance R. The gates of the n-channel transistors MN1 and MN2 are coupled each other, and an intercoupling point thereof is coupled to a terminal of the bias voltage Vcm. A common gate voltage Vcm is supplied to the transistors MN1 and MN2. The n-channel transistor MN1 has a substrate terminal thereof coupled to a source terminal thereof, and the n-channel transistor MN2 also has a substrate terminal thereof coupled to a source terminal thereof.

The p-channel transistor MP3 has a gate thereof coupled to the drain of the p-channel transistor MP2, a source thereof coupled to the terminal of the power supply voltage VDD, and a drain thereof coupled to a drain of the n-channel transistor MN3. The n-channel transistors MN3 and MN4 have gates thereof coupled each other, and an intercoupling point thereof is coupled to the drain of the n-channel transistor MN3. Sources of the n-channel transistors MN3 and MN4 are coupled to a terminal of a reference potential VSS, and the transistors MN3 and MN4 constitute a current mirror.

The transistors MP1 and MP2 constitute the current mirror, and the similar current I1 flows therethrough. As described above, in the case when the channel length L of the transistor is short, and/or, in the case when a threshold voltage Vth of the transistor is low, an error current easily occurs due to a drain voltage difference between the n-channel transistors MN1 and MN2, however, in this embodiment, the transistors MP3, MN3 and MN4 are used, and the drain voltages of the n-channel transistors MN1 and MN2 are controlled to be substantially the similar, and thereby, the error current may be decreased, and the appropriate bias current I1 is generated to keep gm constant.

Next, it is explained that the bias circuit in this embodiment constitutes a negative feedback system. When the drain current I2 of the n-channel transistor MN2 becomes larger than the drain current I1 of the p-channel transistor MP2, a gate voltage of the p-channel transistor MP3 lowers, and a drain current of the p-channel transistor MP3 becomes large. A gate voltage of the n-channel transistor MN4 then becomes high, and a drain current of the n-channel transistor MN4 becomes large.

When the drain current of the n-channel transistor MN4 becomes large, the drain current of the n-channel transistor MN1 varies larger than the drain current of the n-channel transistor MN2, and the drain current I1 of the n-channel transistor MN1 becomes large. Thereafter, the currents I1 and I2 stabilize in a state where the currents I1 and I2 become the similar.

The current made by adding the drain currents of the n-channel transistors MN1 and MN2 is to be the drain current of the n-channel transistor MN4. When the drain current of the n-channel transistor MN4 varies, as described above, the drain current of the n-channel transistor MN1 varies larger than the drain current of the n-channel transistor MN2. The reason thereof will be described later.

In contrast, when the drain current I2 of the n-channel transistor MN2 becomes smaller than the drain current I1 of the p-channel transistor MP2, the gate voltage of the p-channel transistor MP3 rises, and the drain current of the p-channel transistor MP3 becomes small. The gate voltage of the n-channel transistor MN4 then lowers, and the drain current of the n-channel transistor MN4 becomes small. When the drain current of the n-channel transistor MN4 becomes small, the drain current of the n-channel transistor MN1 varies larger than the drain current of the n-channel transistor MN2, and the drain current I1 of the n-channel transistor MN1 becomes small. Thereafter, the currents I1 and I2 stabilize in a state where the currents I1 and I2 become the similar.

According to the above-described negative feedback control, the currents I1 and I2 stabilize in a state where the currents I1 and I2 become the similar, and the drain voltages of the transistors MN1 and MN2 have the similar value, and thereby, it makes it possible to generate the appropriate bias current I1 to keep gm constant, for example.

In the transistor MN4, a drain current 2×I1, being an added value of the drain current I1 of the transistor MN1 and the drain current I2 (=I1) of the transistor MN2 flows. The channel width W of the transistor MN4 is twice as large as the channel width W of the transistor MN3. Since the transistors MN3 and MN4 constitute the current mirror, the drain current I1 flows in the transistor MN3. Accordingly, the bias current I1 flows in the transistor MP3 similarly to in the transistor MN3. The bias circuit may generate the bias current I1 that flows in the transistor MP3. At this time, the size of the transistor MP3 is the similar as that of the transistor MP1, and also the similar bias current I1 flows in the transistor MP3. Consequently, the gate voltage of the transistor MP3 is the similar as that of the transistor MP1, and the drain voltages of the transistors MN1 and MN2 of which the respective gates are coupled become equal.

Next, a current characteristic of the transistors MN1 and MN2 and the principle on which the bias circuit constitutes the negative feedback system are explained in detail. For example, it is set that the channel width W of the transistor MN2 is four times as large as that of the transistor MN1, the channel widths W of the transistors MP1 to MP3 are all the similar, and the channel width W of the transistor MN4 is twice as large as that of the transistor MN3, and thereby, resulting in the bias circuit performing an expected operation.

In order to explain the operation of this bias circuit and the system being the negative feedback system, the characteristics of the portions of the transistors MN1 and MN2, and the resistance R being the core in the circuit are explained.

FIG. 2 is a view where the transistors MN1, MN2 and the resistance R are extracted from FIG. 1, and the gate voltage between the transistors MN1 and MN2 is newly set as Vg in relation to the reference potential, with the drain voltage Vs of the n-channel transistor MN4 being a reference.

The respective currents at a time that the transistors MN1 and MN2 are operating in the saturation region are set as I1 and I2, and the respective characteristics will be led hereinafter.

For the current I1 of the transistor MN1, the threshold voltage is set as Vth and a coefficient is set as β, and the current I1 of the transistor in the saturation region is expressed by an expression (10) based on the expressions (1) and (3).

I1=(β/2)×(Vg−Vth)² (10)

On the other hand, in the transistor MN2, the potential of the source is higher than the reference potential by I2×R due to the current I2 and the resistance R, and further, the channel width W is four times as large as that of the transistor MN1 therefore, the coefficient β is four times as large as that of the transistor MN1. Accordingly, the current I2 of the transistor MN2 is expressed by an expression (11).

I2=(4×β/2)×(Vg−I2×R−Vth)² (11)

When (Vg−Vth) in the expression (11) is modified, it is expressed by an expression (12).

Vg−Vth=I2×R+√(I2/(2×β)) (12)

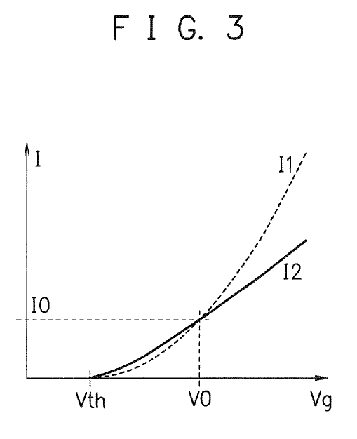

FIG. 3 is a graph depicting a relation between the currents I1 and I2 and the voltage Vg based on the expressions (10) and (12). There is exhibited a first characteristic that the currents I1 and I2 are in a relation of I2>I1 when the voltage Vg is lower than a balanced voltage V0, and in contrast, the currents I1 and I2 are in a relation of I1>I2 when the voltage Vg is higher than the voltage V0. Further, there is exhibited a second characteristic that a total of the currents I1 and I2 increases monotonically in relation to the voltage Vg.

As for the configuration having such characteristics in FIG. 2, there is provided the control system in which the voltage Vg becomes large when the voltage Vg is lower than the voltage V0 (in the case of I2>I1), and the voltage Vg becomes small when the voltage Vg is higher than the voltage V0 (in the case of I1>I2), and thereby, the system may be referred to as “the negative feedback system such that the voltage Vg is controlled by the balanced voltage V0”.

Here, a circuit operation is considered in the case when the voltage Vg is the balanced voltage V0. At the balanced voltage V0, the currents I1 and I2 become equal, and the equal current is set as I0. And then an expression (13) is established by the expressions (10) and (11).

(β/2)×(Vg−Vth)²=(4×β/2)×(Vg−I0×R−Vth)² (13)

When square roots on both sides of the expression (13) are removed and the expression (13) is rearranged, the expression (13) is modified to the following expression (14).

I0×R=(Vg−Vth)/2 (14)

Further, transconductance gm1 of the transistor MN1 is expressed by a following expression (15) after the current I1 in the expression (9) is differentiated from the voltage Vg.

gm1=β×(Vg−Vth)=2×I1/(Vg−Vth) (15)

When the expression (15) is rearranged with regard to I1, an expression (16) is obtained.

I1=gm1×(Vg−Vth)/2 (16)

Here, with a relation of I1=I0, when the expression (16) is substituted for I0 in the expression (14), an expression (17) is obtained.

gm1×R×(Vg−Vth)/2=(Vg−Vth)/2 (17)

When the above is rearranged, gm1 is expressed by an expression (18).

gm1=1/R (18)

Accordingly, in the case when the voltage Vg is controlled by the balanced voltage V0 since the configuration in FIG. 2 is the negative feedback system, it is found that the transconductance gm1 of the transistor MN1 has a characteristic of being proportional to a reciprocal of a resistance element R.

Here, the circuit in FIG. 1 is considered based on the above. The voltage set as Vg in FIG. 2 is a potential difference Vcm−Vs between the gate voltage Vcm common to the transistors MN1 and MN2 and the drain voltage Vs of the transistor MN4 in FIG. 1.

In the configuration in FIG. 1, the transistors MP1 and MP2 constitute the current mirror, and the current of the transistor MP1 (namely the current I1 of the transistor MN1) is replicated in the transistor MP2. Accordingly, the drain voltage of the transistor MN2 varies depending on the magnitude of the current I2 flown from the transistor MN2 and the current I1. flown from the transistor MP1, and in the case of I2>I1, the voltage lowers, and further, in the case of I1>I2, the voltage rises.

The drain voltage of the transistor MN2 is coupled to the gate of the transistor MP3, and varies the drain current of the transistor MP3. The transistor MP3 is the p-channel transistor, and when the gate voltage rises, the drain current becomes small, and when the gate voltage lowers, the drain current becomes large. Further, the variation of the drain current of the transistor MP3 varies the drain current of the transistor MN4 by the current mirror with a twice-scaling factor that the transistors MN3 and MN4 constitute. Accordingly, in the configuration depicted in FIG. 1, in the case of I2>I1, the current of the transistor MN4 increases, and in the case of I1>I2, the current of the transistor MN4 decreases.

Next, the operation of the configuration depicted in FIG. 1 is explained based on the magnitude relation between the currents I1 and I2. In the case of I2>I1, when the current of the transistor MN4 increases, the total of the currents I1 and I2 of the transistors MN1 and MN2 increases, and Vcm−Vs becomes high due to the above-described second characteristic. Further, in the case of I2>I1, Vcm−Vs is lower than V0 due to the first characteristic. Accordingly, the circuit in FIG. 1 is configured so that in the case when Vcm−Vs is lower than V0, Vcm−Vs is controlled to be high.

On the other hand, in the case of I1>I2, from a consideration similar to the above description, the circuit in FIG. 1 is configured so that in the case when Vcm−Vs is larger than V0, Vcm−Vs is controlled to be low.

From the above, the circuit in FIG. 1 has the negative feedback system so that Vcm−Vs is controlled by the balanced voltage V0. Accordingly, it may be said that the transconductance gm1 of the transistor MN1 has the characteristic of being proportional to the reciprocal of the resistance R, and further the current I1 at this time results in the appropriate bias current that realizes this characteristic.

The bias circuit in this embodiment has the configuration to bias the transistors MN1 and MN2 by the transistor MN4 being a common current source. The transistor MN4 being the common current source is feedback-controlled. In the case when biasing the transistor for high-speed operation whose channel length is short and threshold voltage is low as well, the appropriate bias current may be generated.

### Second Embodiment

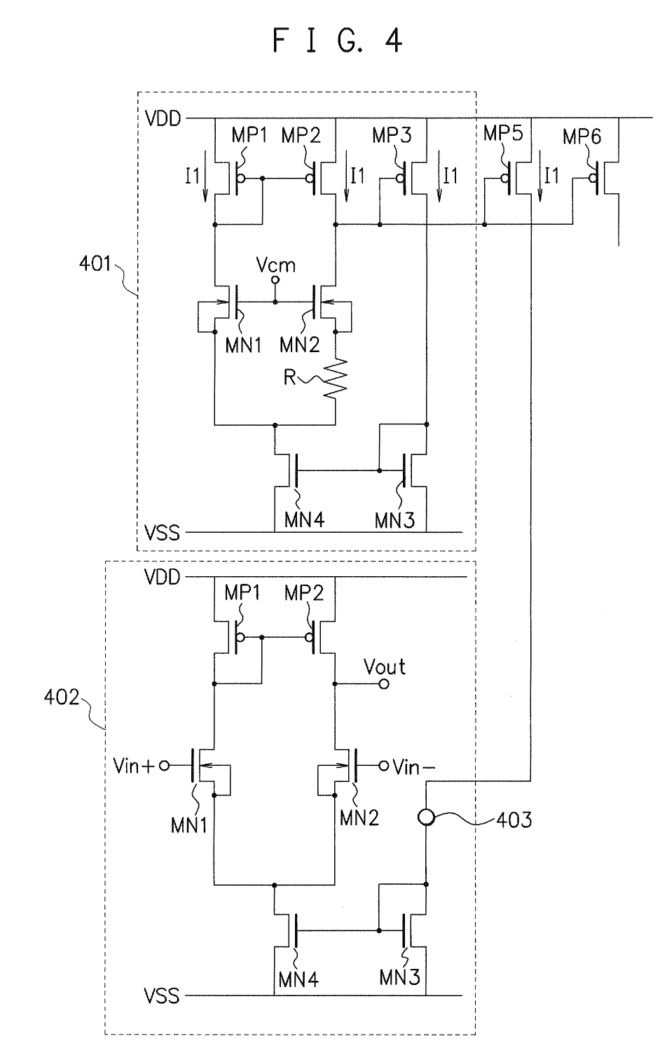

FIG. 4 is a circuit diagram depicting a configuration example of a bias circuit 401 and a differential amplifier 402 according to a second embodiment. The bias circuit 401 is the similar circuit as the bias circuit in FIG. 1.

P-channel transistors MP5 and MP6 have gates thereof coupled to a gate of a p-channel transistor MP3, and sources thereof coupled to a terminal of a power supply voltage VDD. The transistors MP5 and MP6 constitute a current mirror with the transistor MP3. Since a bias current I1 flows in the transistor MP3, the bias current I1 also flows in the transistors MP5 and MP6, and it is, for example to supply the bias current I1 to another circuit. The transistor MP5 supplies the bias current I1 to a bias terminal 403 of the differential amplifier 402.

The differential amplifier 402 is an equal circuit to the bias circuit 401. The point that makes the differential amplifier 402 different from the bias circuit 401 is explained. The differential amplifier 402 inputs differential input signals of a positive input signal Vin+ and a negative input signal Vin−. The positive input signal Vin+ and the negative input signal Vin− are signals whose phases are inverted each other. A gate of a transistor MN1 is coupled to a terminal of the positive input signal Vin+, and a gate of a transistor MN2 is coupled to a terminal of the negative input signal Vin−. A source of the transistor MN2 is coupled directly to a drain of a transistor MN4 without via a resistance R. An output terminal Vout is coupled to an intercoupling point between drains of a transistor MP2 and the transistor MN2. The bias terminal 403 is coupled to a gate and a drain of a transistor MN3. The bias current I1 is supplied to the bias terminal 403 from the transistor MP5.

Since the bias circuit 401 has a circuit configuration equal to that of the differential amplifier 402, the bias circuit 401 and the differential amplifier 402 being a bias object may coincide with each other in terms of operation points of the transistors. That is, in the bias circuit 401 and the differential amplifier 402, the operation points of the corresponding transistors are the similar. The bias circuit 401 may generate the bias current I1 for accurately adjusting a characteristic of the differential amplifier 402 being the bias object. Therefore, the bias circuit 401 is appropriate for generating the bias current I1 for, in particular, the differential amplifier 402.

### Third Embodiment

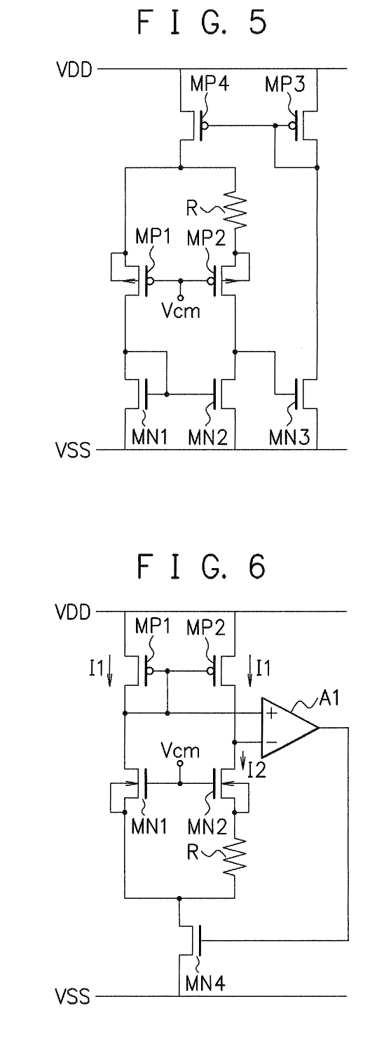

FIG. 5 is a circuit diagram depicting a configuration example of a bias circuit according to a third embodiment. In FIG. 1, the negative feedback system is constituted by using the pair of the n-channel transistors MN1 and MN2, while, in this embodiment, an example will be described in which a negative feedback system is constituted by using a pair of p-channel transistors MP1 and MP2.

N-channel transistors MN1 and MN2 have gates thereof coupled each other, and sources thereof coupled to a terminal of a referential potential VSS. An intercoupling point between the gates of the transistors MN1 and MN2 is coupled to a drain of the transistor MN1. The drain of the transistor MN1 is coupled to a drain of the p-channel transistor MP1, and a drain of the transistor MN2 is coupled to a drain of the p-channel transistor MP2.

A source of the p-channel transistor MP1 is coupled to a drain of a p-channel transistor MP4. A source of the p-channel transistor MP2 is coupled to the drain of the transistor MP4 via a resistance R. Gates of the transistors MP1 and MP2 are coupled each other, and an intercoupling point thereof is coupled to a terminal of a bias voltage Vcm. The transistor MP1 has a substrate terminal thereof coupled to a source terminal thereof, and the transistor MP2 also has a substrate terminal thereof coupled to a source terminal thereof.

An n-channel transistor MN3 has a gate thereof coupled to the drain of the n-channel transistor MN2, a source thereof coupled to the terminal of the reference potential VSS, and a drain thereof coupled to a drain of a p-channel transistor MP3. The transistors MP3 and MP4 have gates thereof coupled each other, and an intercoupling point thereof is coupled to the drain of the transistor MP3. The transistors MP3 and MP4 constitute a current mirror. Sources of the transistors MP3 and MP4 are coupled to a terminal of a power supply voltage VDD.

The bias circuit in this embodiment operates similarly to the circuit in FIG. 1, and may generate a bias current to keep gm constant.

### Fourth Embodiment

FIG. 6 is a circuit diagram depicting a configuration example of a bias circuit according to a fourth embodiment. The bias circuit in this embodiment has transistors MP3 and MN3 eliminated, and a differential amplifier A1 added compared with the bias circuit in FIG. 1. The differential amplifier A1 has a positive input terminal thereof coupled to a drain of a transistor MN1, a negative input terminal thereof coupled to a drain of a transistor MN2, and an output terminal thereof coupled to a gate of a transistor MN4.

When a drain current I2 of the transistor MN2 becomes larger than a drain current I1 of a transistor MP2, a voltage of the negative input terminal of the differential amplifier A1 lowers. Thereafter, an output voltage of the differential amplifier A1 rises, and a drain current of a transistor MN4 becomes large. In contrast, when the drain current I2 of the transistor MN2 becomes smaller than the drain current I1 of the transistor MP2, the voltage of the negative input terminal of the differential amplifier A1 rises. Thereafter, the output voltage of the differential amplifier A1 lowers, and the drain current of the transistor MN4 becomes small. According to this manner, the bias circuit in this embodiment performs the operation similar to that of the bias circuit in FIG. 1, and may generate a bias current I1 to keep gm constant.

### Fifth Embodiment

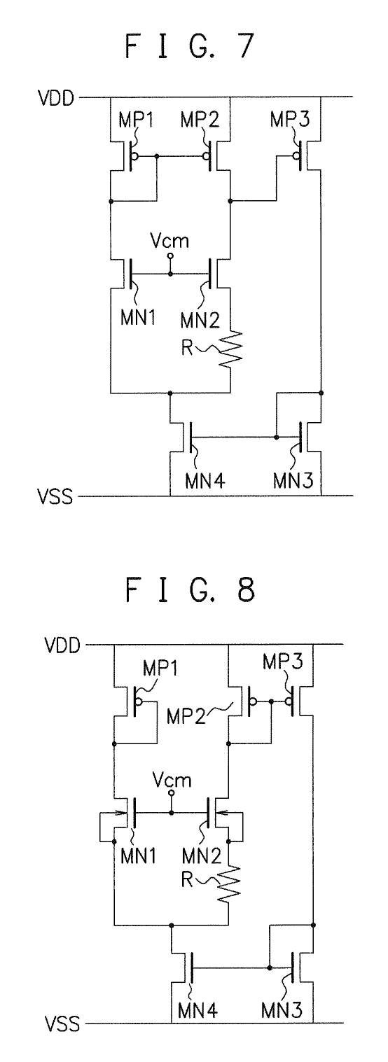

FIG. 7 is a circuit diagram depicting a configuration example of a bias circuit according to a fifth embodiment. In the bias circuit in this embodiment, coupling destinations of substrate terminals of transistors MN1 and MN2 are different compared with the bias circuit in FIG. 1. In the bias circuit in FIG. 1, the transistors MN1 and MN2 have the substrate terminals thereof coupled to the source terminals thereof. In the bias circuit in this embodiment, the transistors MN1 and MN2 have the substrate terminals thereof coupled to a terminal of a reference potential VSS.

At this time, in the transistors MN1 and MN2, substrate-source voltages are different, therefore, a system is to be influenced by a substrate bias effect. At this time, there occurs a current error of a product of transconductance gmb of the substrate bias effect and a potential difference ΔV between the source terminals of the transistors MN1 and MN2, however, it is normal that gmb is a smaller value than gm. In this configuration as well, a bias current such that gm of the transistor is approximately inversely proportional to a resistance R may be generated. Note that the current error due to the substrate bias effect does not occur in the bias circuit in FIG. 1.

### Sixth Embodiment

FIG. 8 is a circuit diagram depicting a configuration example of a bias circuit according to a sixth embodiment. In the bias circuit in this embodiment, a coupling destination of a gate of a transistor MP2 is different compared with the bias circuit in FIG. 1. In the bias circuit in FIG. 1, the transistor MP2 has the gate thereof coupled to the gate of the transistor MP1, and constitutes the current mirror with the transistor MP1. In the bias circuit in this embodiment, the transistor MP2 has a gate and a drain thereof coupled each other, and is diode-coupled.

A transistor MP1 and the transistor MP2 in a load circuit do not constitute a current mirror, and are diode-coupled to respective current paths, and a gate of a transistor MP3 is coupled to the gate of the transistor MP2. At this time, the transistors MP2 and MP3 constitute a current mirror, and drain currents of the transistors MP2 (MN2) and MP3 are equal. Further, a current of the transistor MP3 is replicated in a transistor MN4 being a common current source to transistors MN1 and MN2 at a twice-scaling factor by a current mirror that a transistor MN3 and the transistor MN4 constitute. Therefore, it may be said that the total of drain currents of the transistors MN1 and MN2 is equal to the one that is twice as large as the drain current of the transistor MN2. Accordingly, the drain current of the transistor MN1 is controlled to be equal to the drain current of the transistor MN2.

Note that in the case when the current mirror of the transistors MP2 and MP3 and the current mirror of the transistors MN3 and MN4 have an error due to drain voltage dependence in this configuration, an error occurs in a generated bias current. In contrast, the bias circuit in FIG. 1 is barely subjected to such influence.

### Seventh Embodiment

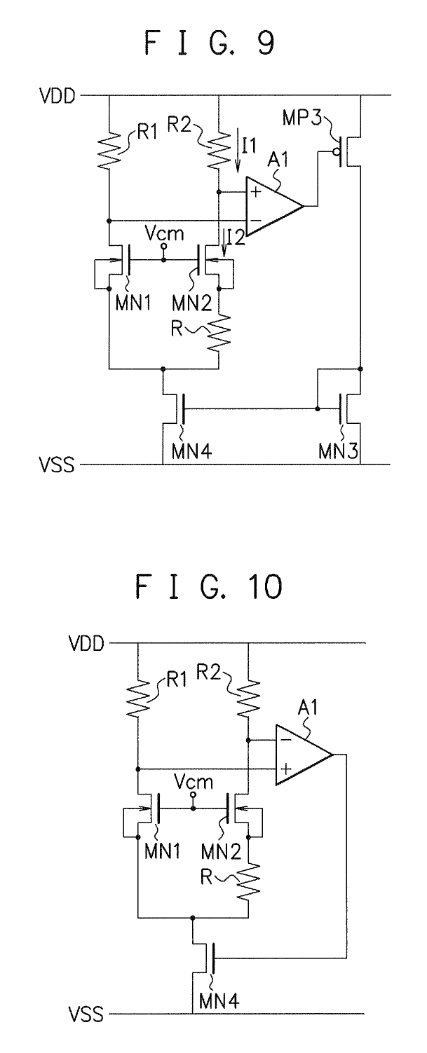

FIG. 9 is a circuit diagram depicting a configuration example of a bias circuit according to a seventh embodiment. In the bias circuit in this embodiment, the load circuit of the current mirror of the transistors MP1 and MP2 is replaced with resistances R1 and R2, and a differential amplifier A1 is added compared with the bias circuit in FIG. 1. The resistance R1 is coupled between a drain of a transistor MN1 and a terminal of a power supply voltage VDD. The resistance R2 is coupled between a drain of a transistor MN2 and the terminal of the power supply voltage VDD. The differential amplifier A1 has a positive input terminal thereof coupled to the drain of the transistor MN2, a negative input terminal thereof coupled to the drain of the transistor MN1, and an output terminal thereof coupled to a gate of a transistor MP3.

When a drain current I2 of the transistor MN2 becomes larger than a current I1 of the resistance R2, a voltage of the positive input terminal of the differential amplifier A1 lowers, and an output voltage of the differential amplifier A1 lowers. Thereafter, a drain current of the transistor MP3 becomes large, a gate voltage of a transistor MN4 rises, and a drain current of the transistor MN4 becomes large. In contrast, when the drain current I2 of the transistor MN2 becomes smaller than the current I1 of the resistance R2, the voltage of the positive input terminal of the differential amplifier A1 rises, and the output voltage of the differential amplifier A1 rises. Thereafter, the drain current of the transistor MP3 becomes small, the gate voltage of the transistor MN4 lowers, and the drain current of the transistor MN4 becomes small.

The bias circuit in this embodiment, similarly to the bias circuits in FIG. 1 and FIG. 6, constitutes a negative feedback system such that a drain current of the transistor MN1 is equal to the drain current of the transistor MN2, and may generate a similar bias current. Further, the resistances R1 and R2 used herein may be replaced with various load circuits, and the bias circuit may be also configured with for example, the load circuit configured with the diode-coupled transistors MP1 and MP2 in FIG. 8, and so on.

### Eighth Embodiment

FIG. 10 is a circuit diagram depicting a configuration example of a bias circuit according to an eighth embodiment. The bias circuit in this embodiment has a simpler configuration than that of the bias circuit in FIG. 9. The bias circuit in this embodiment is made by replacing the load circuit of the current mirror of the transistors MP1 and MP2 of the bias circuit in FIG. 6 with resistances R1 and R2. The resistance R1 is coupled between a drain of a transistor MN1 and a terminal of a power supply voltage VDD. The resistance R2 is coupled between a drain of a transistor MN2 and the terminal of the power supply voltage VDD.

The bias circuit in this embodiment also constitutes a negative feedback system such that a drain current of the transistor MN1 is equal to a drain current of the transistor MN2, and may generate a similar bias current. It is possible to output the bias current in an n-channel transistor based on a gate voltage of a transistor MN4 in this bias circuit, for example. Further, in the case when the circuit to employ the bias current is the differential amplifier 402 with a similar configuration as depicted in FIG. 4, the gate of the transistor MN4 is directly coupled to the gate of the transistor MN3 being the common current source of the differential amplifier 402, and thereby, the bias current may be supplied to the differential amplifier 402.

### Ninth Embodiment

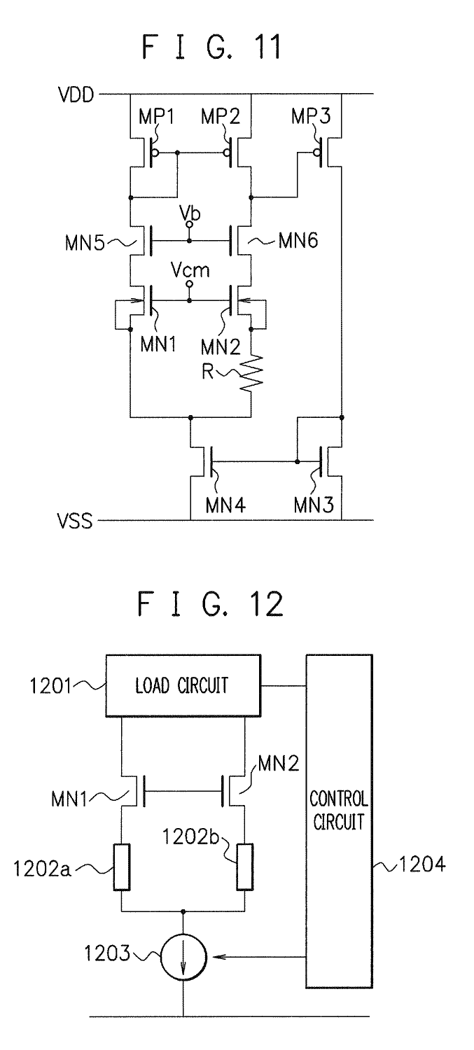

FIG. 11 is a circuit diagram depicting a configuration example of a bias circuit according to a ninth embodiment. N-channel transistors MN5 and MN6 are added to the bias circuit in this embodiment compared with the bias circuit in FIG. 1. The transistor MN5 is cascode-coupled to a transistor MN1, and the transistor MN6 is cascode-coupled to a transistor MN2. That is, the transistor MN5 has a gate thereof coupled to a terminal of a bias voltage Vb, a drain thereof coupled to a drain of a transistor MP1, and a source thereof coupled to a drain of the transistor MN1. The transistor MN6 has a gate thereof coupled to the terminal of the bias voltage Vb, a drain thereof coupled to a drain of a transistor MP2, and a source thereof coupled to a drain of the transistor MN2.

It is possible to employ a cascode circuit for differential pair transistors MN1 and MN2 in order to increase an output resistance in the differential amplifier 402 in FIG. 4, for example. In the bias circuit in this embodiment as well, the configuration of a portion corresponding to differential pairs of the n-channel transistors MN1, MN2, MN5 and MN6 results in the cascode circuit configuration. In the case when the circuit being a bias object is the differential amplifier 402 in FIG. 4 and the differential pair transistors MN1 and MN2 in the differential amplifier 402 configure the cascode circuit, as a result that the bias circuit also adopts the cascode circuit configuration as depicted in this embodiment, accuracy of a bias current to be supplied is further increased.

### Tenth Embodiment

FIG. 12 is a circuit diagram depicting a configuration example of a bias circuit according to a tenth embodiment, N-channel transistors MN1 and MN2 have gates thereof coupled each other, and a common gate voltage is supplied thereto. The transistor MN1 has a drain thereof coupled to a load circuit 1201, and a source thereof coupled to a reference potential terminal via an impedance circuit 1202a and a current source 1203. The transistor MN2 has a drain thereof coupled to the load circuit 1201, and a source thereof coupled to the reference potential terminal via an impedance circuit 1202b and the current source 1203. A control circuit 1204 generates a control signal based on a signal (a voltage or a current) from the load circuit 1201, and controls a current of the current source 1203. The current source 1203 is coupled to the transistors MN1 and MN2 in common.

The load circuit 1201 corresponds to the transistors MP1, MP2, or the resistances R1, R2 in the above-described embodiments. The control circuit 1204 corresponds to the transistors MP3, MN3, or the differential amplifier A1 in the above-described embodiments. The current source 1203 corresponds to the transistor MN4 in the above-described embodiments. The impedance circuits 1202a and 1202b correspond to the resistance R in the above-described embodiments. Both of the impedance circuits 1202a and 1202b may be provided, or only either one of the impedance circuits 1202a and 1202b may be provided.

### Eleventh Embodiment

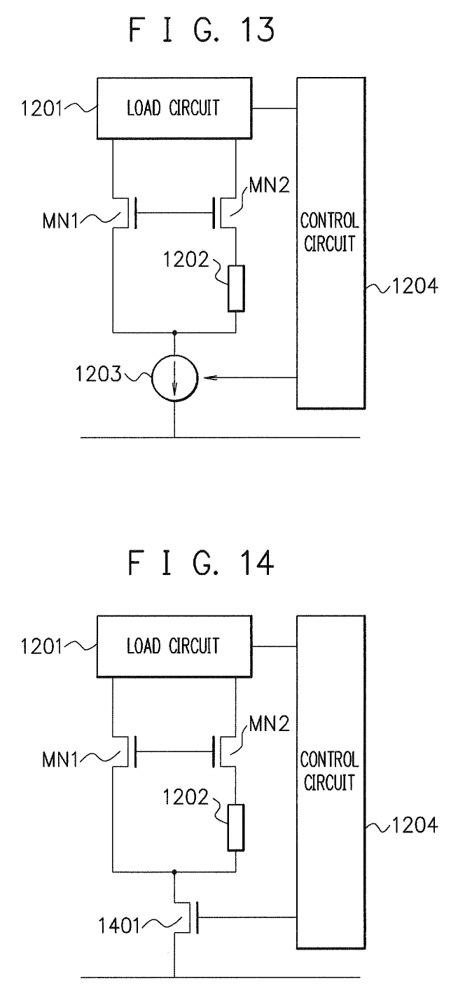

FIG. 13 is a circuit diagram depicting a configuration example of a bias circuit according to an eleventh embodiment. The bias circuit in this embodiment has a single impedance circuit 1202 provided instead of the two impedance circuits 1202a and 1202b in the bias circuit in FIG. 12. The impedance circuit 1202 corresponds to the resistance R in the above-described embodiments, and is coupled between a source of a transistor MN2 and a current source 1203. A source of a transistor MN1 is directly coupled to the current source 1203.

### Twelfth Embodiment

FIG. 14 is a circuit diagram depicting a configuration example of a bias circuit according to a twelfth embodiment. An example is depicted that the bias circuit in this embodiment is configured that the current source 1203 in the bias circuit in FIG. 13 is replaced with an n-channel transistor 1401. The transistor 1401 has a gate thereof coupled to a control circuit 1204, a drain thereof coupled to an intercoupling point between a drain of a transistor MN1 and an impedance circuit 1202, and a source thereof coupled to a reference potential terminal. The transistor 1401 corresponds to the transistor MN4 in the above-described embodiments. The control circuit 1204 controls a gate voltage of the transistor 1401.

### Thirteenth Embodiment

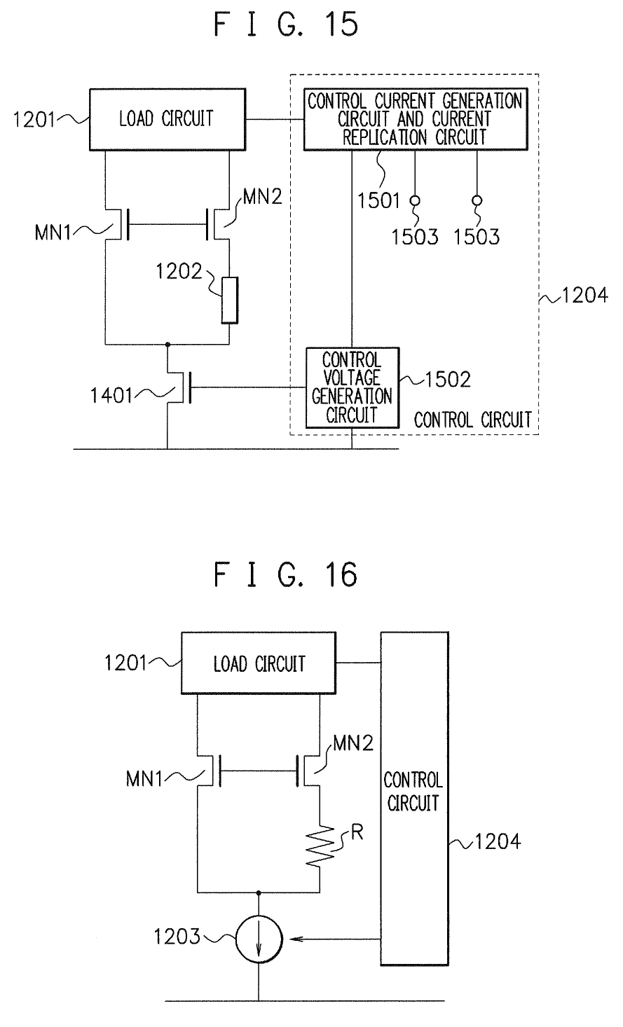

FIG. 15 is a circuit diagram depicting a configuration example of a bias circuit according to a thirteenth embodiment. The bias circuit in this embodiment depicts the control circuit 1204 in the bias circuit in FIG. 14, for example. A control circuit 1204 has a control current generation circuit and current replication circuit (current mirror circuit) 1501 and a control voltage generation circuit 1502. The control current generation circuit 1501 corresponds to the transistor MP3 in the above-described embodiments. The current replication circuit 1501 corresponds to the transistors MP5 and MP6 in FIG. 4, and may replicate a current that flows in a load circuit 1201, and output a bias current to a plurality of current output terminals 1503. The control voltage generation circuit 1502 corresponds to the transistor MN3 in the above-described embodiments.

### Fourteenth Embodiment

FIG. 16 is a circuit diagram depicting a configuration example of a bias circuit according to a fourteenth embodiment. An example is depicted that the bias circuit in this embodiment is configured that the impedance circuit 1202 in FIG. 13 is replaced with a resistance R. The resistance R is coupled between a source of a transistor MN2 and a current source 1203. The resistance R may be configured by using a resistance element or a transistor.

As described above, according to the first to the fourteenth embodiments, an appropriate bias current may be generated by using a low power supply voltage, for example, 1.2V, and even in the case when a threshold voltage of a transistor is low. Further, even in the case when a channel length of the transistor is short, the appropriate bias current may be generated. As high performance of an analog circuit advances in the future, high speed and lowering voltage of a circuit advance. Accordingly, the channel length of the transistor becomes short, and the threshold voltage lowers. In that case, it is difficult for the bias circuit in FIG. 17 to generate the appropriate bias current, however, the bias circuits in the embodiments may generate the appropriate bias current.

Note that the above-described embodiments are to be considered in all respects as illustrative and no restrictive. Namely, the present invention may be embodied in other examples without departing from the spirit or essential characteristics thereof.

A highly accurate bias current may be generated regardless of a channel length or a threshold voltage of a transistor. Consequently, even in the case when a high speed transistor or a low power supply voltage is used, the highly accurate bias current may be generated.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A bias circuit comprising:
a first and a second transistors to which a common gate voltage is supplied;
a load circuit coupled to drains of the first and the second transistors;
a control circuit generating a control signal based on a signal from the load circuit;
a current source controlled based on the control signal and coupled to the first and the second transistors; and
a first impedance circuit coupled between the second transistor and the current source.

2. The bias circuit according to claim 1, wherein
the first transistor is directly coupled to the current source.

3. The bias circuit according to claim 1, further comprising:
a second impedance circuit coupled between the first transistor and the current source.

4. The bias circuit according to claim 1, wherein
in the first and the second transistors, ratios Id/K of a drain current Id to ratios K=W/L between a channel width W and a channel length L are different from each other.

5. The bias circuit according to claim 4, wherein
in the first and the second transistors, the channel lengths L are the same and the ratios Id/W of the drain current Id to the channel widths W are different from each other.

6. The bias circuit according to claim 1, wherein
the current source is configured by a third transistor, and
the control circuit controls a gate voltage of the third transistor.

7. The bias circuit according to claim 1, further comprising:
a current mirror circuit replicating a current flowing in the load circuit to make a bias current flow.

8. The bias circuit according to claim 1, wherein
the first impedance circuit is a resistance.

9. The bias circuit according to claim 8, wherein
the resistance is configured by a resistance element or a transistor.

10. The bias circuit according to claim 1, wherein
the load circuit comprises:
a third transistor coupled to the first transistor; and
a fourth transistor coupled to the second transistor.

11. The bias circuit according to claim 10, wherein
the third and the fourth transistors constitute a current mirror.

12. The bias circuit according to claim 1, wherein
the control circuit comprises:
a third transistor having a gate thereof coupled to the load circuit; and
a fourth transistor having a gate and a drain thereof coupled to the third transistor and the current source.

13. The bias circuit according to claim 1, wherein
the control circuit comprises:
a differential amplifier having two input terminals thereof coupled to the first and the second transistors.

14. The bias circuit according to claim 13, wherein
an output terminal of the differential amplifier is coupled to the current source.

15. The bias circuit according to claim 13, wherein
the load circuit comprises:
a first resistance element coupled the first transistor; and
a second resistance element coupled to the second transistor.

16. The bias circuit according to claim 13, wherein
the control circuit comprises:
a third transistor having a gate thereof coupled to an output terminal of the differential amplifier; and
a fourth transistor having a gate and a drain thereof coupled to the third transistor and the current source.

17. The bias circuit according to claim 1, further comprising:
a third transistor cascode-coupled to the first transistor; and
a fourth transistor cascode-coupled to the second transistor.

18. The bias circuit according to claim 1, wherein
the load circuit comprises:
a third transistor coupled to the first transistor; and
a fourth transistor coupled to the second transistor,
the control circuit comprises:
a fifth transistor having a gate thereof coupled to the load circuit; and
a sixth transistor having a gate and a drain thereof coupled to the fifth transistor and the current source, and
the current source comprises:
a seventh transistor having a gate thereof coupled to the sixth transistor.

19. The bias circuit according to claim 18, wherein
the third and the fourth transistors constitute a current mirror.

20. The bias circuit according to claim 1, wherein
the load circuit comprises:
a third transistor coupled to the first transistor; and
a fourth transistor coupled to the second transistor,
the control circuit comprises:
a differential amplifier having two input terminals thereof coupled to the first and the second transistors, and
the current source comprises:
a fifth transistor having a gate thereof coupled to the control circuit.
